(19) United States
(12) Patent Application Publication
(10) Pub. No.: US 2025/0304099 A1
(43) Pub. Date: Oct. 2, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yuki Kitamura, Tokyo (JP)

(21) Appl. No.: 19/062,265

(22) Filed: Feb. 25, 2025

(30) Foreign Application Priority Data
Mar. 27, 2024 (JP) 2024-051476

(51) Int. Cl. B60W 50/16; B60W 30/12; B60W 50/14; G06V 20/56

(52) U.S. Cl. CPC B60W 50/16; B60W 30/12; G06V 20/588; B60W 2050/143; B60W 2050/146; B60W 2420/403; B60W 2552/30

(57) ABSTRACT

A vehicle control device includes a recognizer configured to recognize a surrounding situation of a vehicle, a determiner configured to determine whether the vehicle is likely to depart from a traveling lane, and a controller configured to output a departure alarm to a driver when the determiner determines that the vehicle is likely to depart from the traveling lane, in which the departure alarm includes a first departure alarm when the traveling lane of the vehicle is other than a curved road and a second departure alarm when the traveling lane of the vehicle is the curved road, the first departure alarm and the second departure alarm give an alarm in an alarm aspect of at least one stage with a different alarm degree, and the controller gives an alarm with a number of stages smaller than that of the first departure alarm, in the second departure alarm.

### CROSS-REFERENCE TO RELATED APPLICATION

Priority is claimed on Japanese Patent Application No. 2024-051476, filed Mar. 27, 2024, the content of which is incorporated herein by reference.

### BACKGROUND

### Field of the Invention

The present invention relates to a vehicle control device, a vehicle control method, and a storage medium.

### Description of Related Art

In recent years, efforts have been actively made to provide access to a sustainable transportation system with special attention to people in vulnerable situations among traffic participants. To implement this, research and development for further improving the safety or convenience of traffic through research and development regarding a preventive safety technique has been focused on. In this context, in recent years, a technique that increases auxiliary steering torque when determination is made that a driver is in a curve recognition state in which the driver has recognized a curve in front of a host vehicle compared to when determination is not made that the driver is in the curve recognition state, and performs any lane keeping control of alarm notification, information provision, an automatic steering operation of a vehicle, and an automatic braking operation for preventing departure of the vehicle from a lane on the basis of a time until the vehicle reaches a lane boundary line has been disclosed (for example, Japanese Patent No. 5018092 and Japanese Patent No. 6658235).

### SUMMARY

Incidentally, in the preventive safety technique, there is a problem in that appropriate control may not be executed for a departure alarm according to road situations.

To solve the above-described problem, an object of the present application is to provide a vehicle control device, a vehicle control method, and a storage medium capable of performing more appropriate alarm control according to road situations. The present application, in turn, contributes to development of a sustainable transportation system.

A vehicle control device, a vehicle control method, and a storage medium according to the invention employ the following configurations.

(1) A vehicle control device according to an aspect of the invention includes a recognizer configured to recognize a surrounding situation of a vehicle, a determiner configured to determine whether the vehicle is likely to depart from a traveling lane, on the basis of a recognition result of the recognizer, and a controller configured to output a departure alarm to a driver of the vehicle when the determiner determines that the vehicle is likely to depart from the traveling lane, in which the departure alarm includes a first departure alarm when the traveling lane of the vehicle is other than a curved road and a second departure alarm when the traveling lane of the vehicle is the curved road, the first departure alarm and the second departure alarm give an alarm in an alarm aspect of at least one stage with a different alarm degree, and the controller gives an alarm with a number of stages smaller than that of the first departure alarm, in the second departure alarm.

(2) In the aspect of (1) described above, the second departure alarm is an alarm in an aspect with an alarm degree greater than that of an aspect with a smallest alarm degree among different alarm aspects of a plurality of stages of the first departure alarm.

(3) In the aspect of (1) described above, the controller maintains the alarm degree of the second departure alarm when the alarm degree becomes smaller in switching from the second departure alarm to the first departure alarm on the basis of the surrounding situation.

(4) In the aspect of (1) described above, an alarm degree of the second departure alarm is the same as a greatest alarm degree of the first departure alarm.

(5) In the aspect of (1) described above, the controller sets end conditions of the first departure alarm and the second departure alarm to be the same.

(6) A vehicle control method according to another aspect of the present invention includes, by a computer, recognizing a surrounding situation of a vehicle, determining whether the vehicle is likely to depart from a traveling lane, on the basis of the recognized surrounding situation, and outputting a departure alarm to a driver of the vehicle when determination is made that the vehicle is likely to depart from the traveling lane, in which the departure alarm includes a first departure alarm when the traveling lane of the vehicle is other than a curved road and a second departure alarm when the traveling lane of the vehicle is the curved road, the first departure alarm and the second departure alarm give an alarm in an alarm aspect of at least one stage with a different alarm degree, and in the second departure alarm, an alarm is given with a number of stages smaller than that of the first departure alarm.

(7) A computer-readable non-transitory storage medium according to still another aspect of the present invention stores a program for causing a computer to recognize a surrounding situation of a vehicle, determine whether the vehicle is likely to depart from a traveling lane, on the basis of the recognized surrounding situation, and output a departure alarm to a driver of the vehicle when determination is made that the vehicle is likely to depart from the traveling lane, in which the departure alarm includes a first departure alarm when the traveling lane of the vehicle is other than a curved road and a second departure alarm when the traveling lane of the vehicle is the curved road, the first departure alarm and the second departure alarm give an alarm in an alarm aspect of at least one stage with a different alarm degree, and in the second departure alarm, an alarm is given with a number of stages smaller than that of the first departure alarm.

According to the aspects of (1) to (7) described above, it is possible to perform more appropriate alarm control according to road situations.

### BRIEF DESCRIPTION OF THE DRAWINGS

FIG. 1 is a configuration diagram of a vehicle in which a vehicle control device of an embodiment is mounted.

FIG. 2 is a diagram illustrating an example of state transition of a first departure alarm and a second departure alarm in the embodiment.

FIG. 3 is a diagram illustrating a specific example of a departure alarm.

FIG. 4 is a diagram illustrating a departure alarm in a first scene.

FIG. 5 is a diagram illustrating a departure alarm in a second scene.

FIG. 6 is a diagram illustrating a departure alarm in a third scene.

FIG. 7 is a diagram illustrating a departure alarm in a fourth scene.

FIG. 8 is a flowchart illustrating an example of departure alarm processing of the embodiment.

### DESCRIPTION OF EMBODIMENTS

Hereinafter, an embodiment of a vehicle control device, a vehicle control method, and a storage medium of the present invention will be described with reference to the drawings.

### Overall Configuration

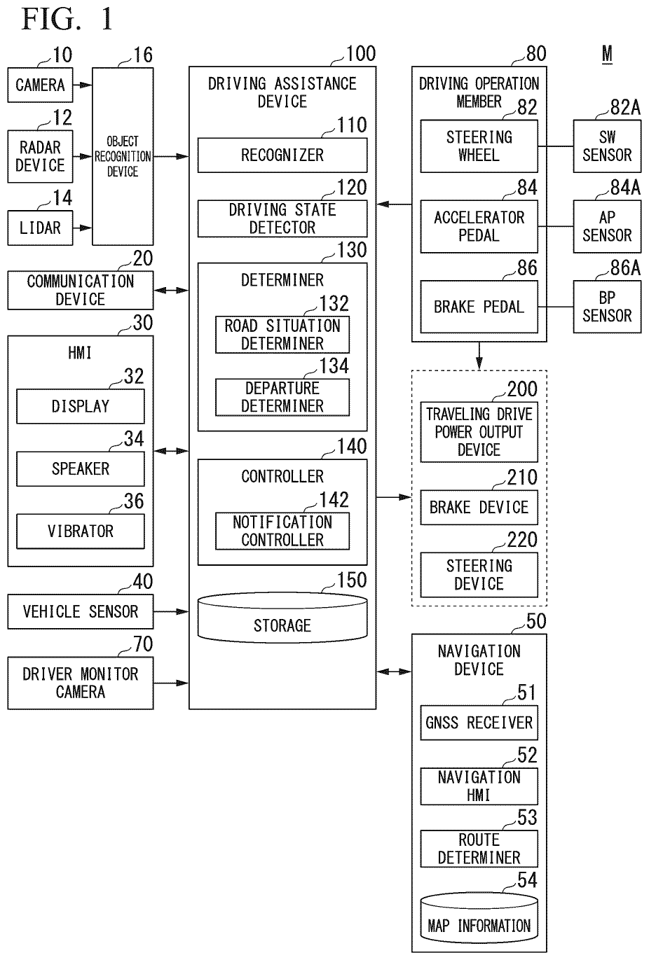

FIG. 1 is a configuration diagram of a vehicle M in which a vehicle control device of an embodiment is mounted. The vehicle M is, for example, a two-wheeled, three-wheeled, or four-wheeled vehicle, and a drive source thereof is an internal combustion engine such as a diesel engine or a gasoline engine, an electric motor, or a combination thereof. The electric motor operates using electric power generated by a generator coupled to the internal combustion engine or electric power discharged from a secondary battery or a fuel cell.

In the vehicle M, for example, a camera 10, a radar device 12, light detection and ranging (LIDAR) 14, an object recognition device 16, a communication device 20, a human machine interface (HMI) 30, a vehicle sensor 40, a navigation device 50, a driver monitor camera 70, a driving operation member 80, a driving assistance device 100, a traveling drive power output device 200, a brake device 210, and a steering device 220 are mounted. These devices and apparatuses are connected to each other by a multiplex communication line such as a controller area network (CAN) communication line, a serial communication line, or a wireless communication network. The configuration shown in FIG. 1 is merely an example, and a part of the configuration may be omitted or another configuration may be added. The HMI 30 is an example of an “alarm” or a “notifier”. The driving assistance device 100 is an example of a “vehicle control device”.

The camera 10 is, for example, a digital camera using a solid-state imaging element such as a charge coupled device (CCD) or a complementary metal oxide semiconductor (CMOS). The camera 10 is attached at any place on the vehicle M. In imaging the front, the camera 10 is attached to an upper portion of a front windshield, a back surface of a rear-view mirror, or the like. The camera 10 periodically and repeatedly images, for example, the vicinity of the vehicle M. The camera 10 may be a stereo camera.

The radar device 12 radiates radio waves such as millimeter waves to the vicinity of the vehicle M, and detects radio waves (reflected waves) reflected by an object to detect at least a position of (a distance to and a direction of) the object. The radar device 12 is attached at any place on the vehicle M. The radar device 12 may detect a position and a speed of an object by a frequency modulated continuous wave (FM-CW) method.

The LIDAR 14 emits light (or electromagnetic waves with a wavelength close to that of light) to the vicinity of the vehicle M and measures scattered light. The LIDAR 14 detects a distance to a target on the basis of a time from light emission to light reception. The emitted light is, for example, pulsed laser light. The LIDAR 14 is attached at any place on the vehicle M.

The object recognition device 16 executes sensor fusion processing on detection results of a part or all of the camera 10, the radar device 12, and the LIDAR 14 to recognize a position, a type, a speed, and the like of an object. The object recognition device 16 outputs a recognition result to the driving assistance device 100. The object recognition device 16 may output the detection results of the camera 10, the radar device 12, and the LIDAR 14 to the driving assistance device 100 without change. The object recognition device 16 may be omitted from the vehicle M. A part or all of the camera 10, the radar device 12, LIDAR 14, and the object recognition device 16 are an example of an “external detection device”.

The communication device 20 communicates with another vehicle in the vicinity of the vehicle M using, for example, a network such as a cellular network, a Wi-Fi network, Bluetooth (Registered Trademark), or dedicated short range communication (DSRC) or communicates with various server devices via a wireless base station.

The HMI 30 presents various kinds of information to an occupant of the vehicle M and receives an input operation by the occupant. The HMI 30 includes, for example, a display 32, a speaker 34, and a vibrator 36. The display 32 is, for example, a liquid crystal display (LCD) or an organic electroluminescence (EL) display. The display 32 displays various images (including videos) in the embodiment. The display 32 may be configured integrally with an input as a touch panel. The speaker 34 outputs prescribed sound (for example, an alarm). The vibrator 36 vibrates at least one of a steering wheel 82 in the driving operation member 80, a seat on which an occupant sits, and a seat belt in use, for example, on the basis of an instruction of the driving assistance device 100. For example, the vibrator 36 notifies a driver hereinafter, referred to as a driver) of the vehicle M of a prescribed situation by vibration. The HMI 30 may be a microphone, a buzzer, a touch panel, a switch, or keys in addition to (or instead of) the display 32, the speaker 34, and the vibrator 36. For example, the HMI 30 may include a selector switch for switching a driving state (the content of driving control) of the vehicle M according to an operation of the driver.

The vehicle sensor 40 includes a vehicle speed sensor that detects a speed of the vehicle M, an acceleration sensor that detects an acceleration, a yaw rate sensor that detects a yaw rate (for example, a rotational angular velocity around a vertical axis passing through the center of gravity of the vehicle M), a lateral acceleration sensor (lateral G sensor) that detects a lateral acceleration (lateral G) of the vehicle M, a direction sensor that detects a direction of the vehicle M, a steering angle sensor that detects a steering angle (an angle of a steered wheel or an operating angle of a steering wheel) of the vehicle M, and the like. The vehicle sensor 40 may be provided with a position sensor that detects a position of the vehicle M. The position sensor may be, for example, a sensor that acquires positional information (longitude/latitude information) from a global positioning system (GPS) device. The position sensor may be a sensor that acquires positional information using a global navigation satellite system (GNSS) receiver 51 of the navigation device 50.

The navigation device 50 includes, for example, the GNSS receiver 51, a navigation HMI 52, and a route determiner 53. The navigation device 50 stores map information 54 in a storage device such as a hard disk drive (HDD) or a flash memory. The GNSS receiver 51 specifies the position of the vehicle M on the basis of signals received from GNSS satellites. The position of the vehicle M may be specified or completed by an inertial navigation system (INS) using an output of the vehicle sensor 40. The navigation HMI 52 includes a display device, a speaker, a touch panel, keys, and the like. The navigation HMI 52 may be partially or entirely shared with the HMI 30 described above. The route determiner 53 determines a route (hereinafter, referred to as an on-map route), for example, from the position of the vehicle M specified by the GNSS receiver 51 (or any input position) to a destination input by the occupant using the navigation HMI 52 with reference to the map information 54. The map information 54 is, for example, information in which a road shape is expressed by a link indicating a road and nodes connected by the link. The map information 54 may include point of interest (POI) information or the like. The map information 54 may include, for example, information regarding a center of a lane or lane boundary information such as a road marking line (hereinafter, referred to as a marking line) that partitions a lane. The map information 54 may include road information such as a radius of curvature (or a curvature) or a slope of a road (or each lane included in a road) and a road width, traffic regulation information, address information (address or zip code), facility information, telephone number information, or the like. The map information 54 may be updated at any time by the communication device 20 communicating with another device. The map information 54 may be stored in a storage in the driving assistance device 100.

The navigation device 50 may perform route guidance using the navigation HMI 52 on the basis of the on-map route. The navigation device 50 may be implemented by, for example, a function of a terminal device such as a smartphone or a tablet terminal owned by the occupant. The navigation device 50 may transmit a current position and a destination to a navigation server via the communication device 20 and may acquire a route equivalent to the on-map route from the navigation server.

The driver monitor camera 70 is, for example, a digital camera using a solid-state imaging element such as a CCD or a CMOS. The driver monitor camera 70 is attached at any place on the vehicle M in a position and a direction in which the head and the upper half of the body (including a position of a hand) of a driver who sits on a driver's seat of the vehicle M is able to be imaged from the front (in a direction in which the face is able to be imaged). For example, the driver monitor camera 70 is attached to an upper portion of a display device provided in a center portion of an instrument panel of the vehicle M. The driver monitor camera 70 outputs an image obtained by imaging a vehicle cabin including the driver of the vehicle M from the disposed position, to the driving assistance device 100.

The driving operation member 80 includes, for example, the steering wheel 82, an accelerator pedal 84, a brake pedal 86, a direction indicator operation switch, a shift lever, and other operation members. A sensor that detects an operation amount or the presence or absence of an operation is attached to the driving operation member 80, and a detection result is output to the driving assistance device 100 or a part or all of the traveling drive power output device 200, the brake device 210, and the steering device 220. The steering wheel 82 is an example of a “steering operation member”. The accelerator pedal 84 and the brake pedal 86 are an example of a “speed operation member”.

For example, the steering wheel 82 is provided with a steering wheel sensor (SW sensor) 82A or a vibrator 36 that vibrates a portion gripped by the driver. The SW sensor 82A detects whether the drier is in contact with the steering wheel 82. The SW sensor 82A detects an operation amount (torque (also referred to as steering torque), a steering amount, or a steering change rate) of the steering wheel 82 that changes according to an operation (hereinafter, referred to as a steering operation) of the driver on the steering wheel 82. The SW sensor 82A may detect whether the driver is gripping the steering wheel 82. The steering wheel 82 is not necessarily in an annular shape, and may be in a form of a deformed steering wheel, a joystick, a button, or the like. In this case, the SW sensor 82A detects an operation amount according to each form.

The accelerator pedal 84 is provided with an accelerator pedal sensor (AP sensor) 84A. The AP sensor 84A detects on or off of an operation (hereinafter, referred to as an accelerator operation) of the driver on the accelerator pedal 84 or an operation amount (an opening degree change amount or an opening degree change rate) of the accelerator pedal 84 that changes according to the operation. The brake pedal 86 is provided with a brake pedal sensor (BP sensor) 86A. The BP sensor 86A detects the on or off of an operation (hereinafter, referred to as a brake operation) of the driver on the brake pedal 86 or an operation amount (an opening degree change amount or an opening degree change rate) of the brake pedal 86 that changes according to the operation. Each of the accelerator operation and the brake operation is an example of a “speed operation”.

The traveling drive power output device 200 outputs traveling drive power (torque) for the vehicle M to travel to drive wheels. The traveling drive power output device 200 includes, for example, a combination of an internal combustion engine, an electric motor, a transmission, and the like, and an electronic control unit (ECU) that controls the internal combustion engine, the electric motor, the transmission, and the like. The ECU controls the above-described configuration according to information input from the driving assistance device 100 or information input from the driving operation member 80.

The brake device 210 includes, for example, a brake caliper, a cylinder that transmits hydraulic pressure to the brake caliper, an electric motor that generates hydraulic pressure in the cylinder, and an ECU. The ECU controls the electric motor according to information input from the driving assistance device 100 or information input from the driving operation member 80 such that a brake torque according to a braking operation is output to each wheel. The brake device 210 may include, as a backup, a mechanism that transmits hydraulic pressure generated by an operation of the brake pedal 86 in the driving operation member 80 to the cylinder via a master cylinder. The brake device 210 is not limited to the configuration described above, and may be an electronically controlled hydraulic brake device that controls an actuator according to information input from the driving assistance device 100 to transmit hydraulic pressure to the master cylinder to the cylinder.

The steering device 220 includes, for example, a steering ECU and an electric motor. The electric motor applies force to a rack-and-pinion mechanism to change a direction of turning wheels, for example. The steering ECU drives the electric motor according to information input from the driving assistance device 100 or information input from the driving operation member 80 and changes the direction of the turning wheels.

### Driving Assistance Device

The driving assistance device 100 includes, for example, a recognizer 110, a driving state detector 120, a determiner 130, a controller 140, and a storage 150. The recognizer 110, the driving state detector 120, the determiner 130, and the controller 140 are implemented by, for example, a hardware processor such as a central processing unit (CPU) executing a program (software). A part or all of these components may be implemented by hardware (circuit, including circuitry) such as a large scale integration (LSI), an application specific integrated circuit (ASIC), a field-programmable gate array (FPGA), a graphics processing unit (GPU), or a system on chip (SOC) or may be implemented by software and hardware in cooperation. The program may be stored in advance in a storage device (a storage device including a non-transitory storage medium) such as an HDD or a flash memory of the driving assistance device 100 or may be stored in a removable storage medium such as a DVD or a CD-ROM and may be installed on the HDD or the flash memory of the driving assistance device 100 when the storage medium (non-transitory storage medium) is loaded into a drive device.

For example, setting inside the traveling drive power output device 200, the brake device 210, and the steering device 220 is performed such that instructions from the driving assistance device 100 to the traveling drive power output device 200, the brake device 210, and the steering device 220 are executed with priority over a detection result from the driving operation member 80. In regard to braking, when a braking force based on an operation amount of the brake pedal 86 is greater than that of an instruction from the driving assistance device 100, setting may be performed such that the braking force is executed with priority. As a structure for executing an instruction from the driving assistance device 100 with priority, a communication priority in an onboard local area network (LAN) may be used.

The storage 150 may be implemented by various storage devices described above or a solid state drive (SSD), an electrically erasable programmable read only memory (EEPROM), a read only memory (ROM), a random access memory (RAM), or the like. The storage 150 stores, for example, the program and other various kinds of information. In the storage 150, the map information 54 described above may be stored.

The recognizer 110 recognizes a surrounding situation of the vehicle M on the basis of information input from the external detection device. For example, the recognizer 110 recognizes a state such as a position, a speed, and an acceleration of an object in the vicinity (for example, within a prescribed distance (first prescribed distance) from the vehicle M). The object is, for example, a traffic participant such as another vehicle, a bicycle, or a pedestrian, or a road structure such as a curbstone, a median strip, or a guard rail. The position of the object is recognized as, for example, a position on absolute coordinates with a representative point (the center of gravity, a drive axis center, or the like) of the vehicle M as an origin and is used for control. The position of the object may also be represented by a representative point such as the center of gravity or a corner of the object or may be represented by a region. The “state” of the object may also include an acceleration or a jerk of the object or an “action state” (for example, whether the object is changing a lane or is about to change a lane) when the object is a mobile object. The recognizer 110 recognizes a relative position or a relative speed with respect to the object.

The recognizer 110 recognizes, for example, a lane (traveling lane) on which the vehicle M is traveling. For example, the recognizer 110 executes known analysis processing (for example, edge extraction, feature quantity extraction, or pattern matching processing) on an image (hereinafter, referred to as a camera image) captured by the camera 10 and recognizes a position or a pattern (for example, an arrangement of solid lines and broken lines) of a marking line in the vicinity of the vehicle M from an analysis result. The recognizer 110 may refer to the map information 54 on the basis of the positional information of the vehicle M and may recognize a position or a pattern of a marking line in the vicinity of the vehicle M. The recognizer 110 may recognize the traveling lane using at least one of the position or pattern of the marking line obtained from the camera image and the position or pattern of the marking line obtained from the map information. The recognizer 110 may recognize the traveling lane by recognizing not only a marking line but also a traveling road boundary (road boundary) including a road shoulder, a curbstone, a median strip, a guard rail, and the like. In the recognition, the position of the vehicle M acquired from the navigation device 50 or a processing result of the INS may be taken into account. The recognizer 110 may recognize an adjacent lane to the traveling lane. The recognizer 110 may recognize a radius of curvature (or a curvature), a slope, a width, or the like of the traveling lane (or road) from at least one of the camera image or the map information. The recognizer 110 recognizes an obstacle, a temporary stop line, a red signal, a toll gate, and other road events from a recognition result of an object. The obstacle is an object that the vehicle M needs to avoid contact, and includes, for example, another vehicle.

The recognizer 110 may recognize a position or a posture of the vehicle M with respect to the traveling lane. The recognizer 110 may recognize, for example, a deviation of a reference point of the vehicle M from a lane center and an angle of a moving direction of the vehicle M with respect to a line connecting lane centers as a relative position and a posture of the vehicle M with respect to the traveling lane. Alternatively, the recognizer 110 may recognize a position or the like of a reference point of the vehicle M with respect to any side end portion (marking line or road boundary) of the traveling lane as a relative position of the vehicle M with respect to the traveling lane. The recognizer 110 may recognize a position or a posture of another vehicle that is traveling on the traveling lane of the vehicle M or may recognize whether another vehicle is present on a center side of the traveling lane or on a marking line side as viewed from the vehicle M.

The driving state detector 120 detects a driving state of the vehicle M of the driver. The driving state includes, for example, a driving state of the vehicle M due to an operation of the driver or a driving state of the vehicle M due to driving control of the controller 140. For example, the driving state detector 120 detects a steering operation (lane keeping steering operation) of the driver for maintaining a state in which the vehicle M is in the traveling lane (for preventing the vehicle M from departing from the lane). For example, the driving state detector 120 detects the lane keeping steering operation by the driver when a steering operation with a steering torque detected by the SW sensor 82A within a prescribed range is detected. The driving state detector 120 may detect the lane keeping steering operation by the driver when the steering operation within the prescribed range has continued for a prescribed time (first prescribed time) or more. The driving state detector 120 may detect the lane keeping steering operation by the driver when the vehicle M is traveling at the lane center due to a steering operation, for example, on the basis of the steering operation and change in distance between right and left marking lines of the vehicle M and the vehicle M.

The driving state detector 120 may detect, for example, a speed operation (an operation to adjust (change) the speed of the vehicle M) of the vehicle M by the driver. In this case, the driving state detector 120 detects, for example, the start (on state) or the end (off state) of an accelerator operation of the driver or an operation amount of the accelerator pedal 84 on the basis of a detection result of the AP sensor 84A. The driving state detector 120 detects the start or the end of a brake operation of a driver or detects an operation amount of the brake pedal 86 on the basis of a detection result of the BP sensor 86A. The driving state detector 120 may detect a speed change amount (acceleration) or the like of the vehicle M according to the speed operation of the driver on the basis of the detection result of the vehicle sensor 40.

The driving state detector 120 may detect whether the driver is in a prescribed state, on the basis of an image captured by the driver monitor camera 70. The prescribed state may be, for example, a state in which the driver is monitoring the front (or the vicinity of the vehicle M) or may be a state in which the driver can quickly take over from driving control on the system side of the vehicle M to manual driving by the driver. “The driver is monitoring the front” means, for example, the line of sight of the driver based on an analysis result of an image captured by the driver monitor camera 70 is facing toward the front (moving direction) of the vehicle M.

The driving state detector 120 may detect a state in which the driver is not performing a driving operation (a state in which the driver is not in contact with the driving operation member 80) or a state in which a driving operation is degraded (in other words, a state in which the driver is driving distractedly) on the basis of the detection result of each of the SW sensor 82A, the AP sensor 84A, and the BP sensor 86A or the state of the driver included in the image captured by the driver monitor camera 70. The driving state detector 120 may detect the type of autonomous driving control that is executed by the controller 140.

The determiner 130 includes, for example, a road situation determiner 132 and a departure determiner 134. The road situation determiner 132 determines a situation of a road on which the vehicle M is traveling. For example, the road situation determiner 132 determines whether a road on which the vehicle M is currently traveling is a curved road or whether there is a curved road within a prescribed distance (second prescribed distance) in the moving direction of the vehicle M, on the basis of the recognition result of the recognizer 110. For example, the road situation determiner 132 determines that the traveling lane is a curved road when a radius of curvature of the traveling lane of the vehicle M is less than a threshold (first threshold). The road situation determiner 132 determines that there is a curved road in the traveling lane when a radius of curvature within the prescribed distance in the moving direction is less than the threshold (first threshold). The road situation determiner 132 may use a curvature instead of the radius of curvature in the curved road determination, and in this case, another threshold is used and determination is performed about whether the curvature is equal to or greater than the threshold. The road situation determiner 132 may determine whether a lane in the moving direction of the vehicle M is a straight line, on the basis of the radius of curvature or the curvature.

The departure determiner 134 determines whether the vehicle M is likely to depart from the traveling lane. For example, the departure determiner 134 determines whether the vehicle M is likely to depart from the traveling lane, on the basis of a positional relationship between right and left marking lines for defining the traveling lane of the vehicle M recognized by the recognizer 110 and the vehicle M or the moving direction or the speed of the vehicle M. The departure determiner 134 may determine whether the vehicle M is departing from the traveling lane at the moment.

For example, the departure determiner 134 determines that the vehicle M is likely to depart from the traveling lane when a reference position (for example, an end portion, the center of gravity, or a center) of the vehicle M is likely to protrude from the traveling lane beyond any marking line out of right and left marking lines for defining the traveling lane recognized by the recognizer 110 (while passing over the marking line), and determines that the vehicle M is not likely to depart from the traveling lane when the reference position is not likely to protrude from the lane.

The departure determiner 134 may change a departure determination condition according to the road situation in the vicinity of the vehicle M determined by the road situation determiner 132. For example, when the lane on which the vehicle M is traveling is a straight road (other than a curved road), the departure determiner 134 determines that the vehicle M is likely to depart from the traveling lane when a shortest distance between the marking line of the traveling lane and the vehicle M is less than a prescribed distance (third prescribed distance), as a first condition, and determines that the vehicle M is not likely to depart from the traveling lane when the shortest distance is equal to or greater than the prescribed distance.

When the lane on which the vehicle M is traveling is a curved road, as a second condition, the departure determiner 134 derives a predicted future route of the vehicle M from the speed and the yaw rate of the vehicle M and calculates a time to line crossing (TTLC) (=d/VM) until the vehicle M reaches the marking line, on the basis of a distance (departure route length d) between the derived predicted route and the marking line (arc), and a speed VM. Then, the departure determiner 134 determines that the vehicle M is likely to depart from the traveling lane when the time to line crossing TTLC is less than a prescribed time (second prescribed time), and determines that the vehicle M is not likely to depart from the traveling lane when the time to line crossing TTLC is equal to or greater than the prescribed time. A target marking line in the second condition may be limited to an outer marking line out of inner and outer marking lines for defining a curved road. For example, when a curved road is curved to the left side, a right marking line is a target marking line, and when a curved road is curved to the right side, a left marking line is a target marking line. When the target marking line in the second condition is limited to the outer marking line as described above, even when the vehicle M is traveling on a curved road, the departure determiner 134 may perform departure determination under the first condition in the positional relationship between the inner marking line and the vehicle M. The departure determiner 134 may perform determination for the straight road under a similar determination condition to the curved road or may perform determination for the curved road under a similar determination condition to the straight road.

The controller 140 controls various functions, devices, and the like of the vehicle M. For example, the controller 140 performs an alarm (notification) to an occupant (including a driver) of the vehicle M or executes driving control of controlling at least one of the speed and steering of the vehicle M on the basis of information obtained from the communication device 20 or the HMI 30, the vehicle sensor 40, the driver monitor camera 70, and the like, information detected by the SW sensor 82A, the AP sensor 84A, and the BP sensor 86A, the recognition result of the recognizer 110, the detection result of the driving state detector 120, the determination result of the determiner 130, and the like.

For example, when the departure determiner 134 determines that the vehicle M is likely to depart from the traveling lane, the controller 140 controls at least one of the HMI 30 and the steering device 220 to execute control (road departure prevention control) of preventing the vehicle M from departing from the traveling lane. The road departure prevention control is, for example, executing (activating) at least one of control (a) to control (c) described below.
(a) The controller 140 outputs, to the HMI 30, information (image, sound, or the like) indicating that the vehicle M is likely to depart or for prompting the driver to perform a steering operation or a speed operation such that the vehicle M does not depart.
(b) The controller 140 vibrates the steering wheel 82 using the vibrator 36. (c) The controller 140 controls the steering device 220 such that the vehicle M returns to the center of the traveling lane (keeps the position in the lane) (steering reaction force control).

In the control (a) described above, control of turning on or flickering an output that outputs prescribed light instead of (or in addition to) outputting an image or sound may be included. In the control (b) described above, control of vibrating a seat on which the driver sits or a seat beat in use instead of (or in addition to) vibrating the steering wheel 82 may be included. “The controller 140 executes at least one of the control (a) and the control (b) described above” is an example of outputting a “departure alarm”. In the departure alarm, the control (c) described above may be included. In the road departure prevention control, another control of assisting the vehicle M or the driver such that the vehicle M does not depart from the lane may be included.

The controller 140 may execute driving control such as adaptive cruise control system (ACC) control of making the vehicle M perform constant-speed traveling on the traveling lane at a speed (set speed) set in advance on the basis of the recognition result of the recognizer 110 or the like, an instruction of the driver from the HMI 30, or the like, a lane keeping assistance system (LKAS) control of making the vehicle M travel at the center of the traveling lane, or auto lane change (ALC) control of operating at least steering of the vehicle M to make the vehicle M change a lane. The controller 140 may execute various kinds of driving control such as collision mitigation brake system (CMBS) control of warning the driver to perform braking control of the vehicle M when the vehicle M is likely to come into contact with an obstacle or emergency stop control of stopping the vehicle M at a safe position. When such driving control is executed, the controller 140 executes autonomous driving control of automatically controlling at least one of steering and the speed of the vehicle M.

The controller 140 includes, for example, a notification controller 142. The notification controller 142 notifies the occupant (including the driver) of prescribed information with the HMI 30. The prescribed information includes, for example, information related to traveling of the vehicle M such as information regarding the state of the vehicle M or information regarding driving control. Information regarding the state of the vehicle M includes, for example, the speed of the vehicle M, an engine rotation speed, and a shift position. Information regarding driving control includes, for example, the type of driving control (driving state) in execution, a reason for activation of driving control, a situation of driving control, and information indicating that the driving control starts or ends. Information regarding driving control may include an alarm (for example, departure alarm) to the driver or information for prompting the driver to perform a prescribed driving operation or to be alert. The prescribed information may include information regarding a current position or a destination of the vehicle M and a residual amount of fuel or information not related to traveling control of the vehicle M such as television programs or contents (for example, movie) stored in a storage medium such as a DVD.

For example, the notification controller 142 may generate an image including the above-described prescribed information and may display the generated image on the display 32 of the HMI 30 or may generate sound indicating the prescribed information and may output the generated sound from the speaker 34 of the HMI 30. A timing at which sound is output is, for example, a timing at which driving control starts or stops, at an incoming call, a timing at which an image to be displayed is switched, and a timing at which the vehicle M is brought into a prescribed state. The notification controller 142 may vibrate the steering wheel 82, the seat, the seat belt, or the like with the vibrator 36 to perform notification (departure alarm) to the driver.

### Notification Control

Next, details of notification control in the notification controller 142 will be specifically described. The notification controller 142 notifies the driver of information regarding the content of driving control, and the like via the HMI 30. For example, the notification controller 142 outputs a departure alarm to the driver when the departure determiner 134 determines that the vehicle M is likely to depart from the traveling lane during manual driving (including during autonomous driving assisting manual driving) of the driver. In the following description, while the departure alarm includes all of the control (a) to the control (c) in the road departure prevention control described above, the present invention is not limited thereto, and one or two of the control (a) to the control (c) may be included.

In the embodiment, the departure alarm includes, for example, a first departure alarm when a traveling road of the vehicle M is a traveling road other than a curved road and a second departure alarm when the traveling road of the vehicle M is a curved road. Each of the first departure alarm and the second departure alarm gives an alarm, for example, in an alarm aspect of at least one stage with a different alarm degree. The “different alarm degree” means that the type and/or the content of the alarm is different. For example, the presence or absence of image display by the display 32, the presence or absence of sound output by the speaker 34, or the presence or absence of vibration output by the vibrator 36 is an example of the different alarm degree. An example of the different alarm degree may include a case where the content or color tone of an image to be displayed is different, a case where the content or volume of sound is different, or a case where the level or interval of vibration is different. “Giving an alarm in an alarm aspect of one stage” is giving an alarm with an alarm degree of one type, and “giving an alarm in alarm aspects of two stages or more” is, for example, giving an alarm with alarm degrees of two types or more in stages over time or according to the level of the likelihood of departure, the situation of departure, or the like. In a case of giving an alarm in alarm aspects of two stages or more, the notification controller 142 gives an alarm such that the alarm degree becomes greater in stages, for example. “Increasing the alarm degree” is increasing the types of alarm and performing highlighting such as displaying an image in color easily visible by the driver or flickering an image, turning up alarm sound, making vibration stronger, and a combination thereof.

The notification controller 142 gives an alarm with the second departure alarm having the number of stages smaller than the first departure alarm, for example. For example, the notification controller 142 sets the second departure alarm in one stage when the first departure alarm has two stages or sets the second departure alarm in two stages when the first departure alarm has four stages. As a result, it is possible to efficiently and certainly transmit a crisis on departure from a curved road to the driver.

Here, since, for example, a curved road and a straight road (an example of a road other than a curved road) are mixed in a traveling road of the vehicle M, appropriate state transition between the first departure alarm and the second departure alarm is required. Accordingly, the notification controller 142 appropriately transitions the departure alarm according to the road situation.

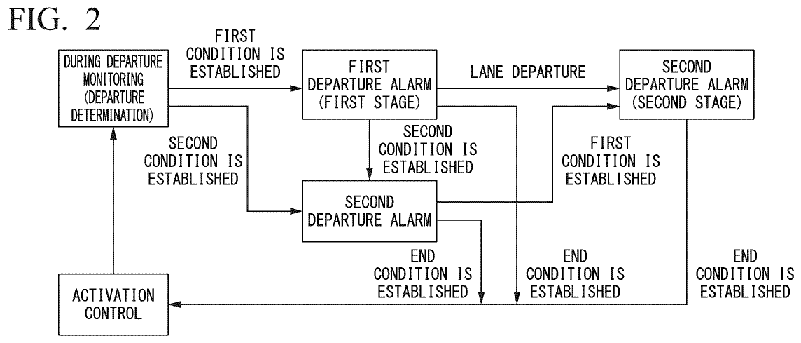

FIG. 2 is a diagram illustrating an example of state transition between the first departure alarm and the second departure alarm in the embodiment. In the example of FIG. 2, the departure determiner 134 continuously performs departure determination in a prescribed period or at a prescribed timing during traveling of the vehicle M (departure monitoring), and in the departure monitoring, the notification controller 142 performs (activates) the first departure alarm (first stage) when the first condition is established (when the first condition is satisfied), and performs the first departure alarm (second stage) with the alarm degree greater than that of the first departure alarm (first stage) when at least a part of the vehicle M departs from the lane. That is, in the example of FIG. 2, in the first departure alarm, to achieve both functionality and acceptability, the action of an alarm is differentiated before and after lane departure, and an alarm is escalated with departure as a trigger. An output condition of the first departure alarm (second stage) may include a condition that determination is made that the vehicle M is likely to depart from the lane even when a prescribed time (third prescribed time) elapses after the first departure alarm (first stage) is output (or even when the vehicle M travels by a prescribed distance (fourth prescribed distance) or more), instead of the condition that at least a part of the vehicle M departs from the lane. When a prescribed end condition is established during the execution (during the activation) of the first departure alarm (second stage), the notification controller 142 prevents (end) the activation of the departure alarm, and departure monitoring is continued. The prescribed end condition is, for example, a condition that a steering operation (lane keeping steering operation) of the driver is detected by the driving state detector 120, a condition that a speed operation (deceleration operation) is detected, or a condition that the departure determiner 134 determines that the vehicle M is not likely to depart from the traveling lane by such an operation.

When the second condition is established during the departure monitoring, the notification controller 142 performs the second departure alarm. In this case, the notification controller 142 performs the second departure alarm in one stage smaller than the first departure alarm. The notification controller 142 sets the second departure alarm as an alarm in an aspect with an alarm degree greater than that of an aspect with the smallest alarm degree among different alarm aspects of a plurality of stages of the first departure alarm. As a result, since a curved road has a high likelihood of departure as much as requiring steering compared to a straight road, it is possible to more efficiently and certainly notify the driver of the degree of emergency (crisis) on departure from the curved road, and to allow the driver to quickly respond.

The notification controller 142 performs switching from the first departure alarm to the second departure alarm and performs notification when the second condition is established during the execution of the first departure alarm (first stage). In this case, the notification controller 142 performs the second departure alarm at an alarm degree (aspect) greater than the first departure alarm (first stage) with the smallest alarm degree. As a result, it is possible to perform a departure alarm in stages, and to more efficiently and certainly notify the driver of the degree of emergency on curve departure.

The notification controller 142 may perform switching to the first departure alarm when the first condition is satisfied during the execution of the second departure alarm. In this case, the notification controller 142 may maintain the alarm degree of the second departure alarm when the alarm degree becomes small due to switching to the first departure alarm. For example, when the second condition is not established and the first condition is established, and when the departure alarm is consecutively activated, since risk avoidance is not possible, it is possible to prevent the driver from misunderstanding a notification content due to an alarm by preventing the alarm degree from becoming small. Accordingly, it is possible to output a more appropriate departure alarm according to a road situation. In the example of FIG. 2, the notification controller 142 performs notification in the first departure alarm (second stage) with the alarm degree the same as or greater than that of a current departure alarm when the first condition is satisfied during the execution of the second departure alarm. The alarm degree of the second departure alarm may be the same as the greatest alarm degree (in FIG. 2, the first departure alarm (second stage)) of the first departure alarm. As a result, even when different departure alarms are consecutively activated, when risk avoidance is not possible, it is possible to prevent the driver from experiencing troublesomeness due to change of the notification by performing similar notification without switching an alarm. Accordingly, it is possible to output a more appropriate departure alarm according to a situation.

When the prescribed end condition is established during the output of the first departure alarm (first stage) or the second departure alarm (for example, when determination is made that the vehicle M is not likely to depart from the lane), the notification controller 142 prevents (ends) the activation of the departure alarm, and departure monitoring is continued. Here, the end conditions of the first departure alarm (first stage and second stage) and the second departure alarm are the same condition. As a result, it is possible to prevent the driver from misunderstanding the notification content when any alarm remains, and to prevent the driver from experiencing troublesomeness due to the notification. The notification controller 142 may change the end condition according to a surrounding situation, a driving situation of the driver, or the like.

### Specific Example of Departure Alarm

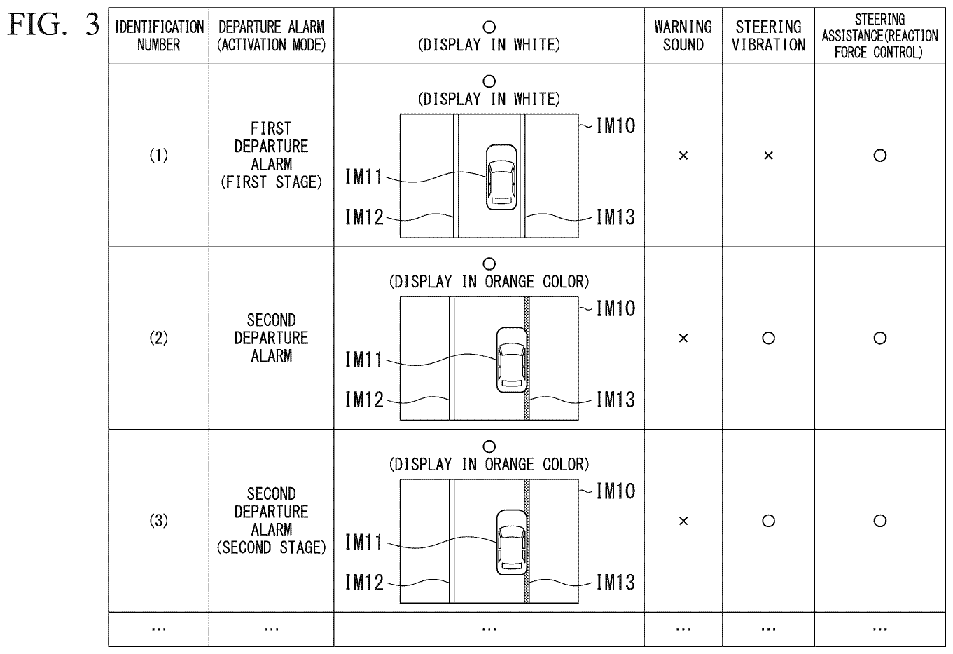

Next, a specific example of a departure alarm in the embodiment will be descried. FIG. 3 is a diagram showing a specific example of a departure alarm. In the example of FIG. 3, for each type (first departure alarm (first stage), second departure alarm, and first departure alarm (second stage)) of departure alarm (activation mode), the content of alarm display, the content of warning sound, vibration (steering vibration) to the steering wheel 82, and the content of steering assistance (reaction force control) are shown. For example, out of the control (a) to the control (c) of the road departure prevention control described above, alarm display and warning sound correspond to the control (a), steering vibration corresponds to the control (b), and steering assistance corresponds to the control (c). A symbol “∘” shown in FIG. 3 indicates that a target alarm is given, and a symbol “x” indicates that a target alarm is not given. In the embodiment, the type or content of an alarm is not limited thereto.

In the example of FIG. 3, in the first departure alarm (first stage) indicated by an identification number (1), alarm display is performed, and an alarm display image IM10 is displayed on the display 32. In the alarm display image IM10, for example, an image IM11 imitating the vehicle M and images IM12 and IM13 imitating right and left marking lines for defining the traveling lane of the vehicle M are displayed at a position corresponding to the position of the vehicle M. In the alarm display in the first departure alarm (first stage), a marking line from which the vehicle M is likely to depart is displayed in color (for example, white) or a pattern similar to another marking line. In the first departure alarm (first stage), the output of warning sound is not performed, and steering vibration is not performed. In the first departure alarm (first stage), steering assistance (reaction force control) is executed.

In the second departure alarm indicated by an identification number (2), as an alarm aspect with an alarm degree greater than that of the first departure alarm (first stage), in the alarm display image IM10 displayed on the display 32, the image IM13 imitating the marking line from which the vehicle M is likely to depart is highlighted (, for example, displayed in orange color) compared to the image IM12 imitating another marking line. In addition, in the second departure alarm, while the output of warning sound is not performed, as an alarm aspect with an alarm degree greater than that of the first departure alarm (first stage), steering vibration is performed. In the second departure alarm (second stage), steering assistance (reaction force control) is executed.

In the first departure alarm (second stage) indicated by an identification number (3), as an alarm aspect with an alarm degree greater than that of the first departure alarm (first stage) in stages, an alarm is given in the same alarm aspect as the second departure alarm. In the first departure alarm (second stage), warning sound may be output. In addition, in the second departure alarm, warning sound may be output. In this case, the warning sound in the first departure alarm (second stage) and the warning sound in the second departure alarm may be the same warning sound, and the warning sound in the first departure alarm (second stage) may be warning sound with an alarm degree greater (for example, volume higher) than that of the warning sound in the second departure alarm. In this way, it is possible to output a more appropriate departure alarm according to a situation, and to allow the driver to be alert regarding a surrounding situation and to quickly perform a steering operation and the like.

### Departure Alarm Based on Behavior of Vehicle M

Next, a departure alarm based on the behavior of the vehicle M with respect to a road situation will be specifically described. Hereinafter, it is assumed that the road situation is near a curved road, and a difference in behavior of the vehicle M will be divided into several scenes and described.

### First Scene

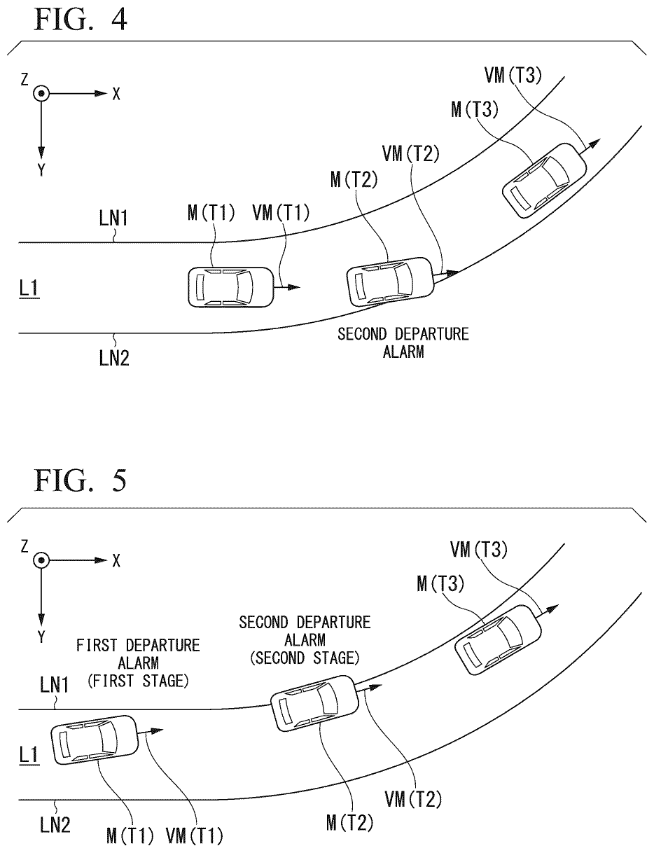

FIG. 4 is a diagram illustrating a departure alarm in a first scene. In an example of FIG. 4, it is assumed that the vehicle M is traveling on a lane L1 at a speed VM (hereinafter, the lane L1 is referred to as a “traveling lane L1” as necessary). The lane L1 is defined by right and left marking lines LN1 and LN2. In the example of FIG. 4, a curved road that is curved to the left side with respect to the moving direction of the vehicle M is shown, and in this case, the marking line LN1 is an inner marking line and the marking line LN2 is an outer marking line. In the example of FIG. 4, at time T*, a position of the vehicle M is represented by M(T*) and a speed of the vehicle M is represented by VM(T*). In the following description, it is assumed that times T1, T2, and T3 are later in this order. It is assumed that the vehicle M is traveling with a manual driving operation of the driver using the driving operation member 80, and a departure alarm (road departure prevention control) can be activated according to a situation.

In the first scene, at time T1, since the departure determiner 134 determines that the vehicle M is not likely to depart from the lane L1, a departure alarm is not output. At time T2, the road situation determiner 132 determines that the traveling lane L1 of the vehicle M is a curved road. In addition, at time T2, the departure determiner 134 determines that the vehicle M is likely to depart from the lane L1 (marking line LN2) under the second condition. In this case, the notification controller 142 outputs the second departure alarm (for example, the alarm aspect of the identification number (2) shown in FIG. 3). At time T3, since determination is made that the vehicle M is not likely to depart from the lane by a steering operation and the like of the driver, the departure alarm ends.

### Second Scene

FIG. 5 is a diagram illustrating a departure alarm in a second scene. The second scene is different from the first scene in that the position of the vehicle M with respect to the lane L1 is different at times T1 to T3. Accordingly, description will be hereinafter provided primarily focusing on a difference of a departure alarm based on a difference in position of the vehicle M. The same applies to a third scene and a fourth scene shown in subsequent drawings.

In the second scene, at time T1, the road situation determiner 132 determines that the traveling lane L1 of the vehicle M is not a curved road. In this case, the departure determiner 134 determines whether the vehicle M is likely to depart from the lane L1 (marking line LN1) under the first condition, and at time T1, determines that the vehicle M is likely to depart from the lane L1. In this case, the notification controller 142 outputs the first departure alarm (first stage) (for example, the alarm aspect of the identification number (1) shown in FIG. 3). At time T2, since at least a part of the vehicle M departs from the lane L1, the first departure alarm (second stage) (for example, the alarm aspect of the identification number (3) shown in FIG. 3) is output. In the second scene, the marking line LN1 is an inner marking line LN1 of the curved road. For this reason, the departure determiner 134 of the embodiment performs departure determination under the first condition without applying the second condition even when the road situation determiner 132 determines that the lane L1 is the curved road. At time T3, since determination is made that the vehicle M is not likely to depart from the lane by a steering operation and the like of the driver, the departure alarm ends.

### Third Scene

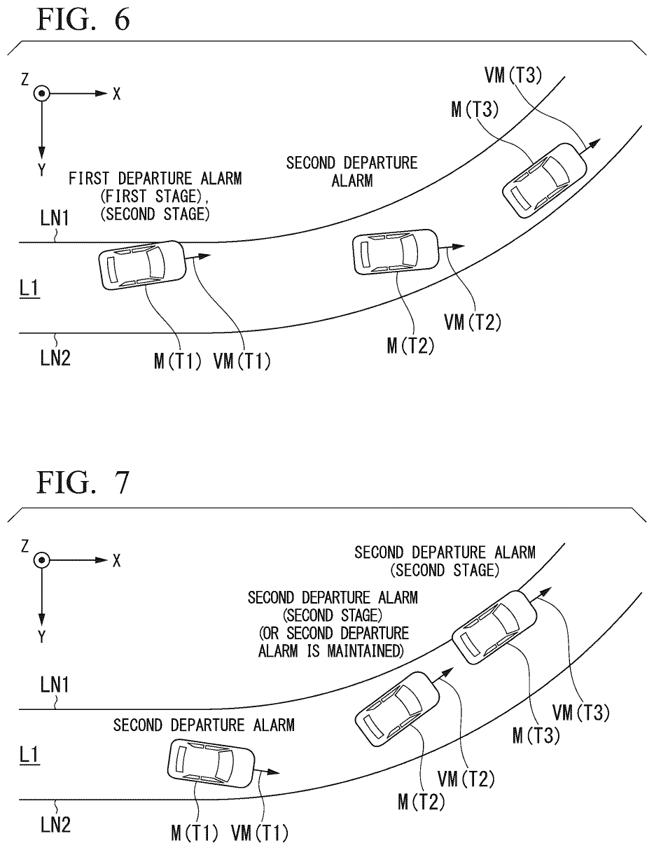

FIG. 6 is a diagram illustrating a departure alarm in a third scene. In the third scene, at time T1, the road situation determiner 132 determines that the traveling lane L1 of the vehicle M is not a curved road. In this case, the departure determiner 134 determines whether the vehicle M is likely to depart from the lane L1 (marking line LN1) under the first condition. In the third scene, it is assumed that determination is made that the vehicle M is likely to depart from the lane L1, and just after, determination is made that at least a part of the vehicle M departs from the lane L1. In this case, the notification controller 142 outputs the first departure alarm (first stage), and thereafter (after a prescribed time (fourth prescribed time) elapses), outputs the first departure alarm (second stage) consecutively (in stages).

At time T2, the road situation determiner 132 determines that the traveling lane L1 of the vehicle M is a curved road. The departure determiner 134 determines that the vehicle M is likely to depart from the lane L1 (marking line LN2) under the second condition. In this case, the notification controller 142 outputs the second departure alarm. In the third scene, in switching of the departure alarm (in switching from the first departure alarm (second stage) to the second departure alarm), it is possible to prevent the driver from experiencing troublesomeness due to switching of the notification by setting the alarm degree (alarm aspect) to be the same.

At time T3, since determination is made that the vehicle M is not likely to depart from the lane by a steering operation and the like of the driver, the departure alarm ends. Here, by setting the end condition of the first departure alarm and the end condition of the second departure alarm to be the same, it is possible to prevent the driver from misunderstanding or experiencing troublesomeness due to the notification when any alarm remains in a situation in which the first departure alarm and the second departure alarm are consecutively output as in the third scene.

### Fourth Scene

FIG. 7 is a diagram illustrating a departure alarm in a fourth scene. In the fourth scene, at time T1, it is assumed that the road situation determiner 132 determines that the traveling lane L1 of the vehicle M is a curved road. In this case, the departure determiner 134 determines whether the vehicle M is likely to depart from the lane L1 (marking line LN2) under the second condition. At time T1, when determination is made that the vehicle M is likely to depart from the lane L1, the notification controller 142 outputs the second departure alarm.

At time T2, while determination is made that the vehicle M is not likely to depart from the lane by a steering operation and the like of the driver, just after (within a prescribed time (fifth prescribed time) after determination, determination is made that vehicle M is likely to depart from the lane L1 (marking line LN1) under the first condition. In this case, the notification controller 142 outputs the first departure alarm (second stage) without setting the alarm degree to be smaller than the second departure alarm (or maintains the alarm degree of the second departure alarm). At time T3, since at least a part of the vehicle M departs from the lane L1, the first departure alarm (second stage) is maintained. In this way, in the fourth scene, it is possible to prevent the driver from misunderstanding the notification or experiencing troublesomeness due to switching of the notification by controlling such that the alarm degree does not become smaller when the second departure alarm is switched to the first departure alarm within a prescribed time.

### Processing Flow

Next, an example of processing that is executed by the driving assistance device 100 in the embodiment will be described using a flowchart. In the following example, description will be provided primarily focusing on departure alarm processing out of processing that is executed by the driving assistance device 100. The following processing shows processing in a situation in which the driver performs manual driving, and LKAS, ALC, or the like by driving control on the system side is not performed. The following processing may be executed repeatedly in a prescribed period or at a prescribed timing.

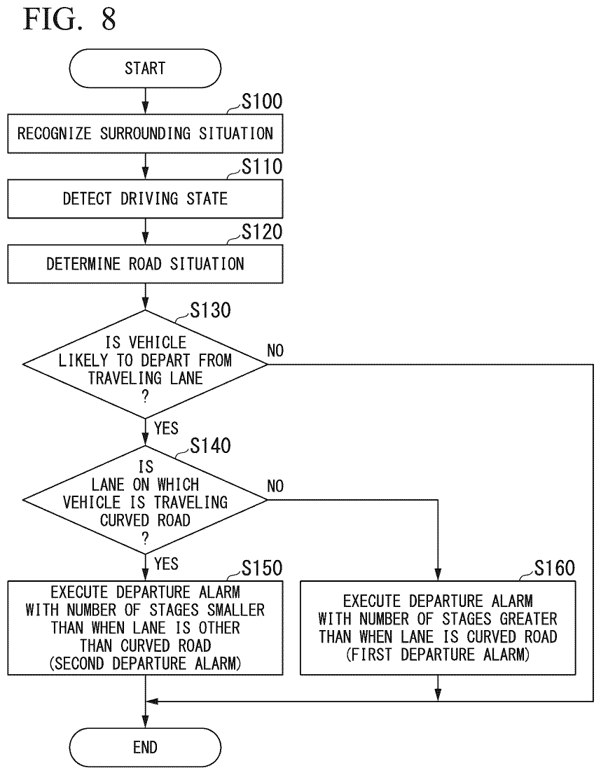

FIG. 8 is a flowchart illustrating an example of departure alarm processing of the embodiment. In the example of FIG. 4, the recognizer 110 recognizes the surrounding situation of the vehicle M (Step S100). Next, the driving state detector 120 detects the driving state of the vehicle M or the driver (Step S110). Next, the road situation determiner 132 determines the rotation situation in the moving direction of the vehicle M (Step S120). In the processing of Step S120, the road situation determiner 132 may determine whether a road in the moving direction of the vehicle M is a curved road (or a straight road), for example.

Next, determination is made whether the vehicle M is likely to depart from the traveling lane (Step S130). When determination is made that the vehicle M is likely to depart from the traveling lane, the notification controller 142 determines whether the lane (the lane in the moving direction) on which the vehicle M is traveling is a curved road, on the basis of a determination result of the road situation determiner 132 (Step S140). When determination is made that the lane on which the vehicle M is traveling is a curved road, the notification controller 142 executes (outputs) a departure alarm (for example, one-stage alarm) with a number of stages smaller than when the traveling lane is other than the curved road (Step S150). The processing of Step S150 corresponds to, for example, the above-described second departure alarm.

In the processing of Step S140, when determination is made that the lane on which the vehicle M is traveling is not the curved road, the notification controller 142 executes a departure alarm (for example, two-stage alarm) with a number of stages greater than when the traveling lane is the curved road (Step S160). The processing of Step S160 corresponds to, for example, the above-described first departure alarm. As a result, the processing of the flowchart ends. In the processing of Step S130, when determination is made that the vehicle M is not likely to depart from the traveling lane, the processing of the flowchart ends.

As described above, the vehicle control device of the embodiment includes the recognizer 110 configured to recognize the surrounding situation of the vehicle M, the determiner 130 configured to determine whether the vehicle M is likely to depart from the traveling lane, on the basis of the recognition result of the recognizer 110, and the controller 140 configured to output the departure alarm to the driver of the vehicle M when the determiner 130 determines that the vehicle M is likely to depart from the traveling lane, in which the departure alarm includes the first departure alarm when the traveling lane of the vehicle M is other than a curved road and the second departure alarm when the traveling lane of the vehicle M is the curved road, the first departure alarm and the second departure alarm give an alarm in an alarm aspect of at least one stage with a different alarm degree, and the controller 140 gives an alarm with a number of stages smaller than that of the first departure alarm, in the second departure alarm. Accordingly, it is possible to perform more appropriate alarm control according to the road situation. Therefore, it is possible to contribute to development of a sustainable transportation system.

For example, in the embodiment, the first departure alarm gives an alarm in a plurality of stages, and the second departure alarm gives an alarm in one stage. In the embodiment, the second departure alarm gives an alarm with an alarm degree greater (stronger) than that of an alarm with a smallest (weakest) alarm degree among a plurality of stages of the first departure alarm. As a result, it is possible to efficiently and certainly transmit the degree of emergency on departure from a curved road to the driver.

In the embodiment, when the alarm degree (strength) becomes smaller in switching from the second departure alarm to the first departure alarm, the alarm degree of the second departure alarm is maintained. In the embodiment, the strongest alarm degree of the first departure alarm and the alarm degree of the second departure alarm are set to be the same. As a result, even when consecutive alarms are activated, it is possible to prevent the driver from misunderstanding the notification content by preventing the alarm degree from being switched to be smaller, and to prevent the driver from experiencing troublesomeness due to the notification or from losing concentration on driving. For example, when an alarm with the greatest (strongest) alarm degree of the first departure alarm is an alarm when the vehicle M departs from the lane, it is possible to perform notification with a large alarm degree before the vehicle M departs from the lane on the curved road, by adjusting the alarm degree of the second departure alarm. Therefore, it is possible to perform notification to the driver early in a situation in which the degree of emergency of departure avoidance is high.

According to the embodiment, it is possible to prevent the driver from misunderstanding the notification content due to any remaining alarm by setting the end conditions of both the first departure alarm and the second departure alarm to be the same, and to prevent the driver from experiencing troublesomeness due to the notification. Therefore, according to the above-described embodiment, it is possible to link the first departure alarm and the second departure alarm more appropriately, and to perform more appropriate alarm control according to the road situation.

The above-described embodiment can be expressed as follows.

A vehicle control device including
a storage medium that stores computer-readable instructions, and
a processor connected to the storage medium,
in which the processor executes the computer-readable instructions to
recognize a surrounding situation of a vehicle, determine whether the vehicle is likely to depart from a traveling lane of the vehicle, on the basis of the recognized surrounding situation, and
output a departure alarm to a driver of the vehicle when determination is made that the vehicle is likely to depart from the traveling lane,
the departure alarm includes a first departure alarm when the traveling lane of the vehicle is other than a curved road and a second departure alarm when the traveling lane of the vehicle is the curved road,
the first departure alarm and the second departure alarm give an alarm in an alarm aspect of at least one stage with a different alarm degree, and
in the second departure alarm, an alarm is given with a number of stages smaller than that of the first departure alarm.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a surrounding situation of a vehicle;
a determiner configured to determine whether the vehicle is likely to depart from a traveling lane, on the basis of a recognition result of the recognizer; and
a controller configured to output a departure alarm to a driver of the vehicle when the determiner determines that the vehicle is likely to depart from the traveling lane,
wherein the departure alarm includes a first departure alarm when the traveling lane of the vehicle is other than a curved road and a second departure alarm when the traveling lane of the vehicle is the curved road,
the first departure alarm and the second departure alarm give an alarm in an alarm aspect of at least one stage with a different alarm degree, and
the controller gives an alarm with a number of stages smaller than that of the first departure alarm, in the second departure alarm.

2. The vehicle control device according to claim 1,
wherein the second departure alarm is an alarm in an aspect with an alarm degree greater than that of an aspect with a smallest alarm degree among different alarm aspects of a plurality of stages of the first departure alarm.

3. The vehicle control device according to claim 1,
wherein the controller maintains an alarm degree of the second departure alarm when the alarm degree becomes smaller in switching from the second departure alarm to the first departure alarm on the basis of the surrounding situation.

4. The vehicle control device according to claim 1,
wherein an alarm degree of the second departure alarm is the same as a greatest alarm degree of the first departure alarm.

5. The vehicle control device according to claim 1,
wherein the controller sets end conditions of the first departure alarm and the second departure alarm to be the same.

6. A vehicle control method comprising:
by a computer,
recognizing a surrounding situation of a vehicle;
determining whether the vehicle is likely to depart from a traveling lane, on the basis of the recognized surrounding situation; and
outputting a departure alarm to a driver of the vehicle when determination is made that the vehicle is likely to depart from the traveling lane,
wherein the departure alarm includes a first departure alarm when the traveling lane of the vehicle is other than a curved road and a second departure alarm when the traveling lane of the vehicle is the curved road,
the first departure alarm and the second departure alarm give an alarm in an alarm aspect of at least one stage with a different alarm degree, and
in the second departure alarm, an alarm is given with a number of stages smaller that of than the first departure alarm.

7. A computer-readable non-transitory storage medium storing a program for causing a computer to:
recognize a surrounding situation of a vehicle;
determine whether the vehicle is likely to depart from a traveling lane, on the basis of the recognized surrounding situation; and
output a departure alarm to a driver of the vehicle when determination is made that the vehicle is likely to depart from the traveling lane,
wherein the departure alarm includes a first departure alarm when the traveling lane of the vehicle is other than a curved road and a second departure alarm when the traveling lane of the vehicle is the curved road,
the first departure alarm and the second departure alarm give an alarm in an alarm aspect of at least one stage with a different alarm degree, and
in the second departure alarm, an alarm is given with a number of stages smaller than that of the first departure alarm.
